(19) United States
(12) Patent Application Publication
(10) Pub. No.: US 2010/0297941 A1
(43) Pub. Date: Nov. 25, 2010

(54) REMOTE CONTROL SYSTEM AND METHOD EMPLOYING CELLULAR TELEPHONES WHICH INCLUDE SHORT RANGE RADIO TRANSCEIVERS

(75) Inventors: Minh N. DOAN, Woodbridge (CA); Michael A. NYKOLUK, Mississauga (CA); Ziyad K. AL-WAKEEL, Toronto (CA)

Correspondence Address: PERRY + CURRIER INC., 1300 YONGE STREET, SUITE 500, TORONTO, ON, M4T-1X3, CA

(73) Assignee: UNIFY4LIFE CORPORATION, Markham (CA)

(21) Appl. No.: 12/625,697

(22) Filed: Nov. 25, 2009

Related U.S. Application Data
(60) Provisional application No. 61/117,637, filed on Nov. 25, 2008.

(51) Int. Cl. G08C 19/00

(52) U.S. Cl. 455/41.2

(57) ABSTRACT

A novel remote control system and method is disclosed which includes a user control and a control module. The system employs one or more cellular telephones as the user control which reduces the cost of the system. Further, by employing the inherent functionality of the cellular telephone, novel modes of interacting with the control module and the target devices it is connected to can be achieved. In the case of the cellular telephone being a smartphone, more advanced modes of interacting with the control module and the target devices can be achieved. Examples of target devices controlled by the system and method include, without limitation, electric garage door openers, lighting systems, thermostats, alarm systems, etc.

### FIELD OF THE INVENTION

The present invention relates to a remote control system and method. More specifically, the present invention relates to a remote control system and method which can be added to existing products, and/or which can be included at time of manufacture of products, and which can interact with one or more cellular telephones which include short range radio transceivers.

### BACKGROUND OF THE INVENTION

Remote controls for consumer products and other devices and systems are well known. For example, many home entertainment devices, such as television sets and audio receivers are equipped with infrared-based remote controls. Other common products are equipped with radio-based remote controls and include garage door opener systems and even vehicle key fobs, used to lock, unlock, etc. their respective vehicles.

While such remote control systems are widely used, they do suffer from some disadvantages. For example, many such remote control systems employ proprietary communications protocols. In the area of infrared-based remote controls, this disadvantage has been mitigated by the widespread adoption of so-called universal remote controls which have been programmed with, or which can “learn” and reproduce, the proprietary protocols of other remote control systems so that multiple devices can be controlled with the universal remote. However, while universal remote controls have improved the situation, consumers are still required to obtain, program and/or configure and maintain the universal remote control.

In a similar fashion, most radio-based remote controls also employ proprietary communications protocols. Generally, an equivalent to a universal remote control for radio-based systems does not exist and this necessitates that a user maintain and use the specific remote control provided by each manufacturer.

Another issue with known remote control systems is that they typically must be incorporated in a device at the time of manufacture and cannot be added by a consumer to a device after purchase. While some exceptions to this circumstance do exist, generally there are no convenient, inexpensive remote control solutions which can be added, after manufacture, to a range of devices.

### SUMMARY OF THE INVENTION

It is an object of the present invention to provide a novel remote control system and method which obviates or mitigates at least one disadvantage of the prior art.

According to a first aspect of the present invention, there is provided a remote control system for controlling a target device, comprising: at least one cellular telephone which also includes a short range radio transceiver, the at least one cellular telephone acting as a user control; and a control module comprising: a short range radio transceiver operable to communicate with the short range radio transceiver of the at least one cellular telephone; a control output assembly operable to change the state of at least one output connected to the target device; and a microcontroller operable to execute a control program and responsive to data received at the short range radio transceiver of the control module to cause the control output assembly to change the state of the at least one output to change the state of the target device.

According to another aspect of the present invention, there is provided a method of using a cellular telephone equipped with a short range radio transceiver to control a target device, comprising the steps of: connecting the target device to a control module including a short range radio transceiver interoperable with the short range radio transceiver in the cellular telephone; initiating a connection between the short range radio transceivers in the cellular telephone and the control module to enable the transmission of at least one command from the cellular telephone to the control module through the interoperable short range radio transceivers; and receiving the at least one command at the control module and controlling the target device in accordance with the received command.

According to yet another aspect of the present invention, there is provided a control module for a remote control system to control a target device, the control module comprising: a short range radio transceiver operable to communicate with the short range radio transceiver of at least one cellular telephone; a control output assembly comprising at least one output connected to the target device; and a microcontroller operable to execute a control program and responsive to data received at the short range radio transceiver of the control module to cause the control output assembly to change the state of the at least one output to change the state of the target device.

The present invention provides a novel remote control system and method which includes a user control and a control module. The system employs one or more cellular telephones as the user control which reduces the cost of the system. Further, by employing the inherent functionality of the cellular telephone, novel modes of interacting with the control module and the target devices it is connected to can be achieved. In the case of the cellular telephone being a smartphone, more advanced modes of interacting with the control module and the target devices can be achieved. Examples of target devices controlled by the system and method include, without limitation, electric garage door openers, lighting systems, thermostats, alarm systems, etc.

The control module can be included by the manufacturer of the target device or can be added by a user after the fact and the system can be used to supplant or replace proprietary remote controls.

### BRIEF DESCRIPTION OF THE DRAWINGS

Preferred embodiments of the present invention will now be described, by way of example only, with reference to the attached Figures, wherein:

FIG. 1 a schematic representation of a remote control system in accordance with the present invention; and

FIG. 2 shows a schematic representation of an electric garage door opener system controlled with the present invention.

### DETAILED DESCRIPTION OF THE INVENTION

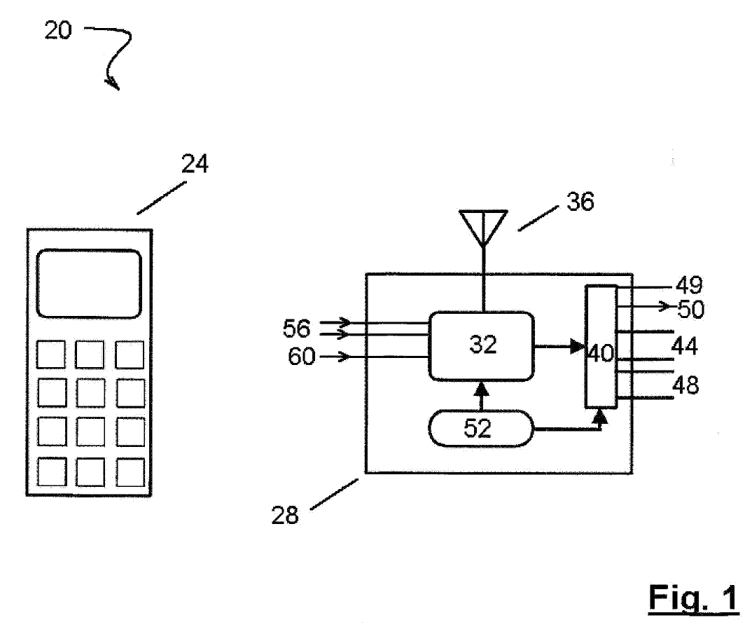

A remote control system, in accordance with an embodiment of the present invention, is indicated generally at 20 in FIG. 1. System 20 includes a cellular telephone 24 which, in addition to the cellular radio transceiver required for operation within the respective cellular network, also includes a short range radio transceiver intended for interoperation with various accessories, such as wireless headsets or hands free units.

The particular design of cellular telephone 24 is not limited and cellular telephone 24 can, for example, be a GSM, CDMA, 3G or other standards-based or proprietary cellular handset which also includes a short range radio transceiver.

As used herein, the term “short range radio transceiver” is intended to distinguish this radio transceiver from the cellular radio transceiver in the cellular telephone 24 and the term “short range” is not intended to otherwise be a limitation with respect to the operation of this transceiver. Accordingly, the short range radio transceiver in cellular telephone 24 is also not particularly limited and can, for example, be a Bluetooth transceiver, a Zigbee transceiver, a WiFi transceiver or any other radio transceiver suitable for exchanging digital information with a cellular telephone accessory. Presently, the most common implementation of such short range radio transceivers are those that comply with the Bluetooth standard and this standard is referred to in the following discussion but, as stated above, the present invention is not limited to use with Bluetooth enabled cellular telephones 24. In the present invention, one or more cellular telephones 24 serve as the user control of the remote control system.

In addition to the user control of cellular telephone 24, system 20 further includes at least one control module 28 to complete system 20. Control module 28 comprises a short range radio transceiver and microcontroller 32 which is interoperable with the short range radio transceiver in cellular telephone 24. In this embodiment of system 20, transceiver and microcontroller 32 is a Bluetooth transceiver, such as a Bluecore 5 device, manufactured by Cambridge Silicon Radio, Cambridge Science Park, Milton Road, Cambridge, UK. The Bluecore 5 device is a single discrete device which, in addition to the Bluetooth transceiver, includes a microcontroller, memory and other functionality. However, the present invention is not limited to transceiver and microcontroller 32 being a single discrete device and it is contemplated that transceiver and microcontroller 32 can be two or more discrete devices, such as a separate transceiver, separate memories and/or a separate microcontroller, if desired and, as used herein, the term transceiver and microcontroller is intended to include comprise such variations.

Transceiver and microcontroller 32 is operably connected to a suitable antenna 36, which can be integrally formed with transceiver and microcontroller 32, or which can be provided as a printed circuit board trace or as an appropriate separate antenna.

Control module 28 further comprises a control output assembly 40 which can provide a variety of control signal outputs, including one or more sets of normally closed (NC) electrical contacts 44 and/or one or more sets of normally open (NO) electrical contacts 48, analog voltage outputs 49 of desired voltage levels and/or serial data outputs 50 such as RS-232 or USB outputs. For example, control output assembly 40 can comprise one or more electromagnetic relays or can comprise a solid state equivalent, such as a suitable transistorized circuit and can comprise the output of a digital to analog converter and/or a serial port, or USB, interface.

Control module 28 further comprises a power supply 52 which can be a battery, an AC to DC power converter or any other suitable power supply as will occur to those of skill in the art and power supply 52 provides suitable operating electrical voltages and currents to each of transceiver and microcontroller 32 and control output assembly 40.

It is also contemplated that in some circumstances, as described in more detail below, control module 28 can include one or more binary inputs 56 and/or one or more serial inputs 60 (such as RS-232 or USB) or a variety of other inputs as may be required for control of specific devices.

Control module 28 is preferably designed to be manufacturable at a relatively low cost. As users of system 20 will already have a suitable cellular telephone 24, the overall cost of owning and operating system 20 can thus be very low and it is contemplated that system 20 will be particularly suitable for use in household environments, although system 20 is not limited to use in such environments.

Examples of target devices which can be controlled with control module 28 include, without limitation, household devices such as electric garage door openers, electric lights, thermostats, alarm and/or security systems, appliances, etc.

Control module 28 must be suitably connected to a target device, with connections being made between one or more outputs, such as electrical connector sets 44 and/or 48, and/or outputs 49 or 50 and/or to one or more of binary inputs 56 or serial input 60 and the target device. Further, a suitable battery must be provided for power supply 52, or power supply 52 must be connected to an AC power supply or other source of electrical energy, as appropriate. Once control module 28 is appropriately connected, transceiver and microcontroller 32 starts execution of a control program stored therein.

Prior to first using a cellular telephone 24 with system 20, the user of system 20 must authenticate that cellular telephone 24 with control module 28. As mentioned above, in the illustrated embodiment of system 20, control module 28 and cellular telephone 24 inter-communicate using the Bluetooth communications protocol. As part of this protocol, each device which will communicate with another device must be “paired” with that other device. This pairing function of the protocol provides security for the communications between the devices in that a Bluetooth device will not communicate with another Bluetooth device it has not previously been paired with. The actual pairing protocol and methods are part of the Bluetooth standard and need not be further discussed herein. It is contemplated that control module 28 can be instructed to start the pairing process by applying an input to one of inputs 56 or that control module 28 can be configured to start the pairing process for some period of time each time power supply 52 is energized.

If a short range communications protocol other than Bluetooth is employed with system 20 any other suitable method, as would occur to those of skill in the art, can be employed to authenticate cellular telephone 24 with control module 28.

Once cellular telephone 24 has been authenticated with control module 28, whether by Bluetooth pairing or other suitable method, a user can use cellular telephone 24 to operate control output assembly 40 to change the state of one or more of electrical connector sets 44, 48 and/or signals on outputs 49 and/or 50 to control the target device to which control module 28 has been connected.

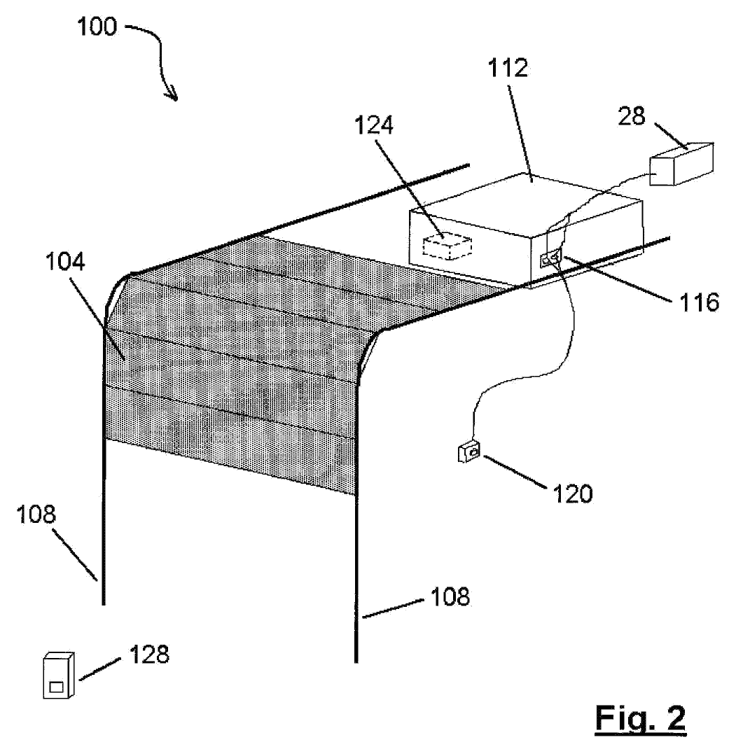

FIG. 2 shows an example wherein system 20 has been installed on an electric garage door opener system 100. In the illustrated embodiment, garage door opener system 100 comprises a sectional garage door 104 which can be moved between an open and a closed position along a pair of guide tracks 108. Garage door opener system 100 further comprises an electric power head assembly 112 which includes an electric drive motor (not shown) that is linked to garage door 104 via a chain, belt or screw drive (also not shown) such that the operation of the electric drive motor moves door 104 along guide tracks 108, between the open and closed positions.

With conventional configurations of garage door opener system 100, electric power head assembly 112 can be controlled in one of two ways. For the first control method, electric power head assembly 112 is typically provided with a pair of normally open electrical contacts 116 which are electrically connected to one or more actuator buttons 120. When one of actuator buttons 120 is pressed, electrical contacts 116 are closed and electrical power head 112 is activated to move door 104.

For the second control method, electrical power head assembly 112 is equipped with a radio receiver 124 which is responsive to a radio-based remote control unit 128 provided by the manufacturer of power head assembly 112. When a user activates the remote control 128, a radio signal is sent from the remote control 128 to radio receiver 124 which will activate power head assembly 112 to move door 104.

It is contemplated that the present invention can easily be retrofitted to existing installed garage door openers, although it is also contemplated that the present invention can be included with power head assembly 112 by the manufacturer, if desired. When the present invention is to be retrofitted to an existing electric garage door opener system 100, control module 28 is installed in the vicinity of the garage door and one of the set of normally open electrical contacts 48 of control module 28 are connected to electrical contacts 116 on power head assembly 112, in a similar manner as actuator button 120.

Power supply 52 of control module 28 is then appropriately powered, by installing a suitable battery in control module 28, connecting control module 28 to an appropriate source of AC electrical energy or in any other suitable manner. In particular, the electrical contacts 116 of many garage door openers represent an open 24VDC circuit. In such a case, power supply 52 can comprise a rechargeable battery and charging regulation circuitry which is energized by the available 24VDC at contacts 116 to power control module 28. In this manner, a user need only connect control module to contacts 116 and no other electrical connections will be required.

If the present invention is provided by the manufacturer of the electric garage door opener, then control module 28 can replace, or supplement, radio receiver 124 and one or more set of normally closed electrical contacts 44 or normally open electrical contacts 48 will be connected, internally, to the appropriate operating circuitry of the power head assembly 112 as will power supply 52.

To operate the garage door opener, the user first authenticates their cellular telephone 24 with control module 28. As mentioned above, if system 20 employs Bluetooth as its short range radio protocol, this authentication is achieved by pairing the two transceivers.

Once cellular telephone 24 has been authenticated with control module 28, the user can send commands from cellular telephone 24 to control module 28, to control power head assembly 112 or other target devices.

One manner in which the user of cellular telephone 24 can send commands to control module 28 is by merely establishing an authenticated communications connection between cellular telephone 24 and control module 28. For example, in the Bluetooth protocol when a Bluetooth device is operating within range of another Bluetooth device to which it has previously been paired, the two devices perform a handshaking operation and connect to each other in preparation for the transfer of data.

Accordingly, in a first method of interacting with control module 28, the user of cellular telephone 24 can configure the Bluetooth transceiver in cellular telephone 24 to Automatically Connect to the Bluetooth transceiver in control module 28 as the user approaches the garage door. When control module 28 connects to the user's cellular telephone 24, transceiver and microcontroller 32 recognizes the connection and causes control output assembly 40 to close normally open electrical contacts 48 to initiate operation of electric power head assembly 112 to open, or close, garage door 104.

Once the user observes that power head assembly 112 has been activated, the user will deactivate the Automatic Connection option of Bluetooth transceiver in cellular telephone 24 to disconnect the Bluetooth transceiver from the Bluetooth transceiver in control module 28. When the user wishes to again operate power head assembly 112 to open, or close, garage door 104, they merely reactivate the Automatic Connection option of Bluetooth transceiver in cellular telephone 24 to reconnect that Bluetooth transceiver to the Bluetooth transceiver in control module 28 which will again causes control output assembly 40 to close normally open electrical contacts 48 to initiate operation of electric power head assembly 112.

This particular mode of operation provides some unique advantages in that the user of cellular telephone 24 can activate the Automatic Connection option in the Bluetooth transceiver in cellular telephone 24 even when the Bluetooth transceiver in cellular telephone 24 is out of range of the Bluetooth transceiver in control module 28. In this manner, a user with cellular telephone 24 is a vehicle can activate the Automatic Connection option in the Bluetooth transceiver when the user is a large distance from the garage door and, as the user approaches the garage door and enters radio communications range of the two Bluetooth transceivers, the Bluetooth transceivers will connect and control module 28 will operate power head assembly 112 to open, or close, the garage door. Thus, for example, a user leaving their office can activate the Automatic Connection option in the Bluetooth transceiver in cellular telephone 24 and, after driving home, the Bluetooth transceiver in cellular telephone 24 will connect with the Bluetooth transceiver in control module 28 as the user approaches their garage door and power head assembly 112 will be activated by control module 28 to open garage door 104.

In a second method of interacting with control module 28, the mere connection of a paired Bluetooth transceiver with the Bluetooth transceiver of control module 28 is not sufficient to activate power head assembly 112. Instead, in this configuration an explicit pre-defined Bluetooth protocol command must be transmitted from cellular telephone 24 to command module 28 to activate power head assembly 112.

In a present embodiment of the invention, control module 28 activates power head assembly 112 upon receiving either an AVRCP “volume up” or “volume down” command. AVRCP is the AudioNideo Remote Control Profile, which is a Bluetooth profile defined for many cellular telephones. In cellular telephone 24, this profile is intended to allow a user of cellular telephone 24 to change the volume of Bluetooth connected headset by pressing a volume up or volume down button on cellular telephone 24. When one of these buttons is pressed, a corresponding Bluetooth volume up or volume down command is transmitted to the Bluetooth connected headset.

While the complete Bluetooth protocol provides a wide range of profiles, and more profiles may be added from time to time, with many commands and/or methods for exchanging data between connected Bluetooth transceivers, the manufacturers of many cellular telephones 24 only implement a small subset of the available protocol and/or profiles.

Accordingly, the present inventors have determined that, as a wide range of cellular telephones 24 include the AVRCP profile, it is a good candidate for sending commands from cellular telephones 24 to control module 28. However, while the following discussion relates to the use of the volume up and/or volume down AVRCP profile, the use of any other suitable Bluetooth command and/or profile is also contemplated.

In the second method of interacting with control module 28, once the Bluetooth transceiver in cellular telephone 24 has connected to the Bluetooth transceiver in control module 28, a pre-selected command, such as the above-mentioned volume up or volume down command is sent from cellular telephone 24 to control module 28.

Unfortunately, with most cellular telephones 24, AVRCP commands cannot be transmitted by the Bluetooth transceiver in cellular telephone 24 until a telephone call has been initiated. So, in this second mode of interacting with control module 28 the user of cellular telephone 24 must initiate a call (i.e.—dial some number and then press the “send” button on cellular telephone 24) and then press the volume up or volume down button on cellular telephone 24 to transmit the pre-selected command to control module 28 to activate power head assembly 112. It is important to note that the call need only be initiated, not completed, and thus the user need only dial, press send, wait briefly for the cellular telephone to start processing the call, and then press the volume up or volume down button (as appropriate) to instruct control module 28 to activate power head assembly 112. The user can then cancel the call, in many cases before it has even been established.

This second method provides some advantages over the above-described first method. Specifically, if multiple devices (i.e.—two garage door openers, etc.) are connected to control module 28, control module 28 can be programmed to change the state of different ones of electrical contact sets 44 and/or 48 in response to the receipt of different commands. So, for example, if a user has two garage doors with respective garage door openers in their house and each garage door opener being connected to a different set of electrical contacts 48 on control module 28, control module 28 can be programmed such that receipt of a volume down command from an authenticated cellular telephone activates one of the two garage door openers and receipt of a volume up command from an authenticated cellular telephone activates the other of the two garage door openers.

As will be apparent to those of skill in the art, the second method is not limited to the use of volume up and volume down commands, nor to the set of AVRCP profile commands. Instead, any suitable available commands from any other Bluetooth profile available on cellular telephone 24 can be employed, if desired.

In a third method of interacting with control module 28, the HSP (Headset Profile) or HFP (Hands Free Profile), or other similar profiles, are used to transmit DTMF tones from cellular telephone 24 to control module 28. With this method, control module 28 includes a DTMF decoder, either implemented in software in transceiver and microcontroller 32 or as a separate discrete device or in any other suitable manner as will occur to those of skill in the art, and the DTMF decoder allows control module 28 to recognize one or more DTMF codes sent as a sequence by cellular telephone 24. Control module 28 is programmed to perform one or more specific actions depending for each recognized sequence. For example, in the above-described example of a user having two garage doors, each equipped with a respective electric garage door opener, control module 28 can be programmed to close a first set of normally open electrical contacts 48 to open (or close) a first one of the garage doors upon receipt of the DTMF sequence “001” and to close a second set of normally open electrical contacts 48 to open (or close) the second one of the garage doors upon receipt of the DTMF sequence “002”.

It is contemplated that the use of DTMF sequences can also provide an increased measure of security by, for example, employing more complicated DTMF sequences (i.e.—six digit or longer) to activate features controlled by control module 28. Thus, even if the Bluetooth pairing security was circumvented and/or cellular telephone 24 were obtained by an unauthorized third party, that third party would not be able to easily command control module 28 as they would not know the necessary DTMF sequences to which control module 28 will respond.

Similar to circumstances of the second method, most cellular telephones 24 will not transmit DTMF tones through their Bluetooth transceivers until a telephone call has been initiated. So, as with the second method, the user of cellular telephone 24 must initiate a call and then dial the desired DTMF sequence to operate the target device, after which they can terminate the call.

As will be apparent to those of skill in the art, the above methods allow for system 20 to exploit the features of the short range radio transceiver, and in particular the Bluetooth protocol, in a manner unintended by the manufacturers of cellular telephones 24 but which are advantageous to the users of system 20.

In each of the methods described above, it has been assumed that cellular telephone 24 only offers a very limited set of Bluetooth profiles, and is thus quite limited in its communications with control module 28. However, more advanced cellular telephones can offer a wider range of available Bluetooth profiles, as well as enhanced user interface elements such as larger displays, enhanced keyboards, touch screens and the ability to execute third party programs. Such advanced cellular telephones are often referred to as “smartphones” and the use of such smartphones with the present invention allows for additional methods of operation with control module 28.

In particular, many smartphones include the Bluetooth Serial Port Profile (SPP) which allows packets of arbitrary information to be exchanged between paired Bluetooth devices. The flexibility offered by the SPP and/or any other profile which allows for the transmission of arbitrary data provides for additional methods of interacting with control module 28.

For example, it is not necessary to initiate a call to transmit or receive data via the SPP profile. Instead, a software application executing on the smartphone 24 can be activated by the user to send appropriate data to control module 28, as desired. Thus, a garage door remote control software application can be executed on smartphone 24 and used to open or close garage door 104 as desired.

Similarly, a software application can be executed on smartphone 24 to control any other target device connected to one or more control modules 28, as desired. Thus an application can be provided and executed on smartphone 24 which allows a user to control two or more garage door openers, household lights, an alarm system, etc. which are target devices connected to a single control module 28.

Further, as the SPP profile allows for the two way exchange of data between connected Bluetooth devices, sensors or other inputs can be attached to binary inputs 56, serial inputs 60 or other inputs to control module 28 and corresponding information can be provided back to the software application executing on smartphone 24, and thus to the user.

For example, a pair of microswitches can be appropriately positioned adjacent garage door 104 such that one switch is closed when the garage door is open and the other switch is closed when the garage door is closed. Each of the microswitches can be connected to one of binary inputs 56 and control module 28 can transmit the status of binary inputs 56 to smartphone 24 which can display, in the remote control application, an indication of whether the garage door is open of closed. As will be apparent, any other sensor or signal of interest can be applied to binary inputs 56 and forwarded to smartphone 24 for display to the user.

Similarly, more sophisticated devices controlled by control module 28 can provide relevant signals to control module 28 through serial input 60. As an example, control module 28 can be inter-connected to a household alarm system (not shown) which it can then control through serial data outputs 50 or other outputs from control module 28. In such a case, a suitable alarm control software application will be executed on smartphone 24 and can provide functionality such as arming or disarming the alarm system. Further, status information from the alarm system can be applied to serial input 60 and transmitted to smartphone 24, where it is displayed by the control software application to the user. For example, an icon can be displayed by the control software application to indicate that the alarm system is armed, or dis-armed, as appropriate.

Similarly, control module 28 can be connected to a thermostat and an appropriate digital temperature sensor can be appropriately connected to serial input 60. In such as case, the control software application executing on smartphone 24 can allow the user to change the set temperature of the thermostat, but also to see the temperature measured by the sensor connected to serial input 60.

Additional advantages can also be obtained by exploiting the computing capabilities of smartphone 24 with the control software application. For example, for the garage door opener remote application, a feature can be provided which allows for time-based preprogrammed operation of the garage door. In this example, a user who commutes from his office to his home after 5:00 PM each week day, can preprogram the control software application such that, each weekday after 5:00 PM, the application will monitor the Bluetooth transceiver in smartphone 24. Upon detecting that the previously paired Bluetooth transceiver in control module 28 has connected to the Bluetooth transceiver in smartphone 24 (which will occur as the user approaches within Bluetooth radio range of control module 28), the software application will automatically send the open command to the control module 28 to open garage door 104, without requiring any action on the user's part. Thus, as the user drives down his street after 5:00 PM on a weekday and approaches his house, his garage door will automatically open.

A similar functionality can be obtained to activate household lights which are connected to control module 28, turning on the controlled lights as the user approaches his home.

Further, if his garage door is equipped with sensors indicating whether the garage door is open or closed, the control software application can examine the status of the garage door as the user approaches and the control software application will only send the open command to control module 28 if the garage door is not already open, etc.

The use of smartphone 24 as a control device for control module 28 can afford other advantages. For example, many smartphones now include global positioning system (GPS) receivers which allow the smartphone to determine its position. In such a case, the position of smartphone 24 (and/or changes to the position of smartphone 24 over time) can be used as another relevant input to the control software application executing of smartphone 24. Thus, for example, a user can configure the control software application such that any time the user drives down his street to approach his house, smartphone 24 will send the open command to control module 28 to open garage door 104 and anytime the user drives down his street to leave his house, the control software application sends the close command to close garage door 104.

As will be apparent to those of skill in the art, the combination of the computing capabilities of smartphone 24 and the capability of providing sensory feed back from inputs 56 and 60 of control module 28 to smartphone 24 can provide for numerous other desirable operating modes and features.

The present invention provides a unique remote control system and method which include a user control and a control module. The system employs one or more cellular telephones as the user control and, as the user need not purchase a special purpose device to act as the user control for the system, and as a cellular telephone can interact with more than one control module, the overall cost of the system is reduced. Further, by employing the inherent functionality of the cellular telephone, novel modes of interacting with the control module and the target devices it is connected to can be achieved. In the case of the cellular telephone being a smartphone, even more advanced modes of interacting with the control module and the target devices can be achieved. Examples of target devices controlled by the system and method include, without limitation, electric garage door openers, lighting systems, thermostats, alarm systems, etc.

The above-described embodiments of the invention are intended to be examples of the present invention and alterations and modifications may be effected thereto, by those of skill in the art, without departing from the scope of the invention which is defined solely by the claims appended hereto.

We claim:

1. A remote control system for controlling a target device, comprising:
at least one cellular telephone which also includes a short range radio transceiver, the at least one cellular telephone acting as a user control; and
a control module comprising:
a short range radio transceiver operable to communicate with the short range radio transceiver of the at least one cellular telephone;
a control output assembly operable to change the state of at least one output connected to the target device; and
a microcontroller operable to execute a control program and responsive to data received at the short range radio transceiver of the control module to cause the control output assembly to change the state of the at least one output to change the state of the target device.

2. The remote control system of claim 1 wherein the at least one cellular telephone is operable to execute a control program, the control program being responsive to user inputs to cause the short range radio transceiver to transmit at least one command to the control module.

3. The remote control system of claim 2 wherein the control module is operable to transmit data, corresponding to a signal applied to an input of the control module, to the control program executing on the cellular telephone.

4. A method of using a cellular telephone equipped with a short range radio transceiver to control a target device, comprising the steps of:
connecting the target device to a control module including a short range radio transceiver interoperable with the short range radio transceiver in the cellular telephone;
initiating a connection between the short range radio transceivers in the cellular telephone and the control module to enable the transmission of at least one command from the cellular telephone to the control module through the interoperable short range radio transceivers; and
receiving the at least one command at the control module and controlling the target device in accordance with the received command.

5. The method of claim 4 wherein the at least one command comprises the establishment of the connection between the short range radio transceivers in the cellular telephone and the control module.

6. The method of claim 4 wherein the at least one command comprises a predefined command which is transmittable from the cellular telephone after the user activates a key on the cellular telephone.

7. The method of claim 6 wherein the selected key is a volume control key.

8. The method of claim 4 wherein the at least one command comprises a predefined DTMF sequence entered by the user of the cellphone.

9. The method of claim 8 wherein the control module is responsive to at least two different predefined DTMF sequences to place the target device into at least two different states.

10. A control module for a remote control system to control a target device, the control module comprising:
a short range radio transceiver operable to communicate with the short range radio transceiver of at least one cellular telephone;
a control output assembly comprising at least one output connected to the target device; and
a microcontroller operable to execute a control program and responsive to data received at the short range radio transceiver of the control module to cause the control output assembly to change the state of the at least one output to change the state of the target device.

11. A control module according to claim 10 wherein the at least one output comprises a pair of normally open connections.

12. A control module according to claim 10 wherein the at least one output comprises a pair of normally closed connections.

13. A control module according to claim 10 wherein the at least one output comprises a digital serial output.

14. A control module according to claim 10 further comprising at least one input and the state of the at least one input is reported to the cellular telephone by the control module.

15. A control module according to claim 14 wherein the at least one input is a digital input.

16. A control module according to claim 10, further comprising a DTMF decoder.
